(19) United States
(12) Patent Application Publication
(10) Pub. No.: US 2011/0222266 A1
(43) Pub. Date: Sep. 15, 2011

(54) ELECTRONIC DEVICE WITH ILLUMINATED OPERATING ELEMENT

(75) Inventor: Andreas BEERMANN, Stuttgart (DE)

(73) Assignee: Sony Corporation, Tokyo (JP)

(21) Appl. No.: 13/040,827

(22) Filed: Mar. 4, 2011

(30) Foreign Application Priority Data
Mar. 12, 2010 (EP) 10002641.8

(51) Int. Cl. F21V 33/00

(52) U.S. Cl. 362/85

(57) ABSTRACT

An illuminating element (110) of an electronic device (100) is associated to an operating element (120), which may be a control element (122) or a connector socket (121). A controller (130) performs a user-guidance procedure or an input port selection procedure and controls the illuminating element (110) in dependence on a progress of the procedure. For example, in case of an operating manual display procedure or a help procedure, connector sockets (121) and/or control elements (122), to which the on-screen operating manual or the help procedure currently refers, may be illuminated in the relevant context. Other embodiments refer to the illumination of operating elements (120) that could or should be operated at a certain point in time in the course of an input port selection procedure.

### FIELD OF INVENTION

Embodiments of the invention relate to the field of electronic devices having operating elements that are operable by a user, for example switches, connectors or regulators.

### BACKGROUND

Electronic devices, for example, electronic devices typically provide a couple of connector sockets for receiving interconnection cables via which the user connects the electronic device, for example a television set, with further electronic devices like a set-top box, a video recorder or a camcorder. In each case, the user has to find and select the correct one of the available connector sockets, which are often placed on the rear side of the apparatus casing.

It is an object of the invention to provide an electronic device with enhanced user operability. The object is achieved by the subject-matter as claimed in the independent claims. More advanced embodiments are defined in the dependent claims.

Details of the invention will become more apparent from the following description of embodiments in connection with the accompanying drawings. The features of the various embodiments may be combined with each other unless they exclude each other.

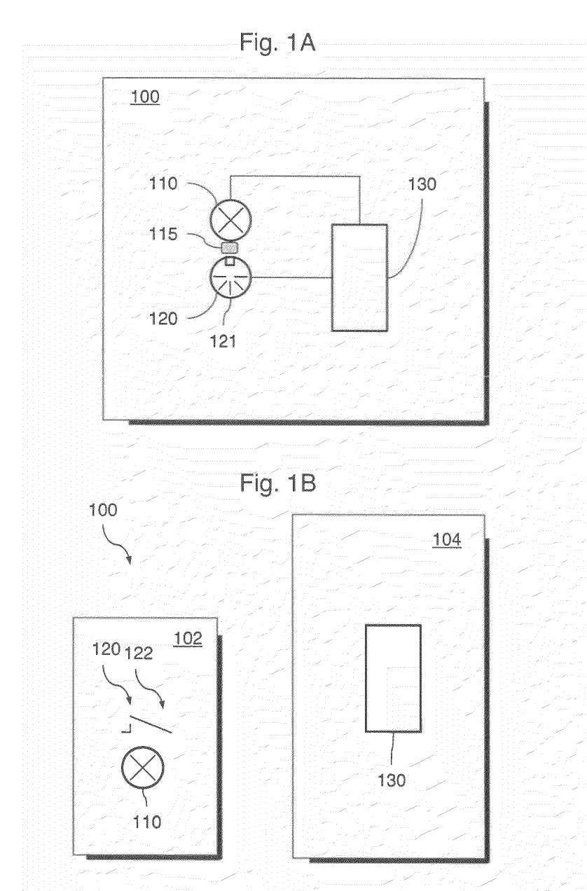

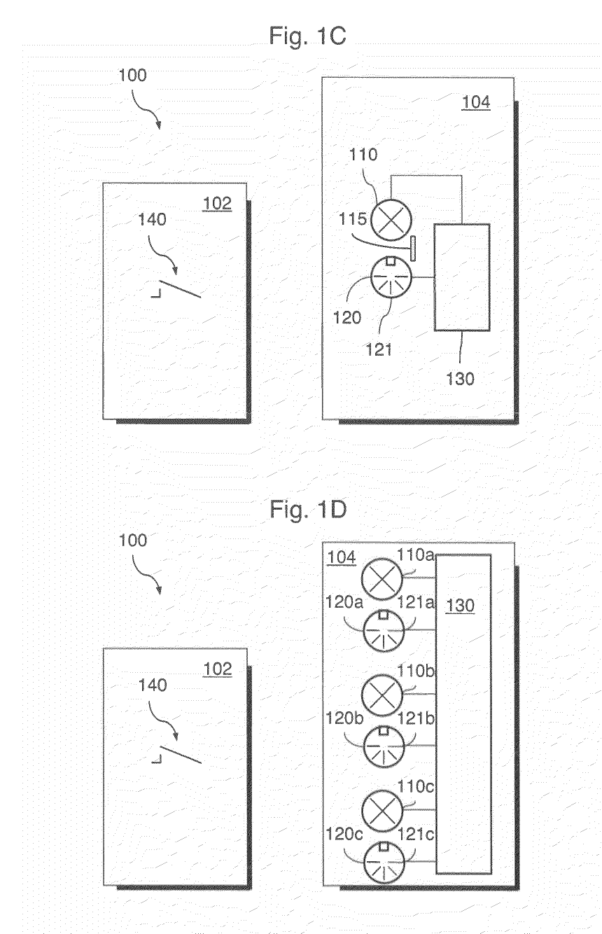

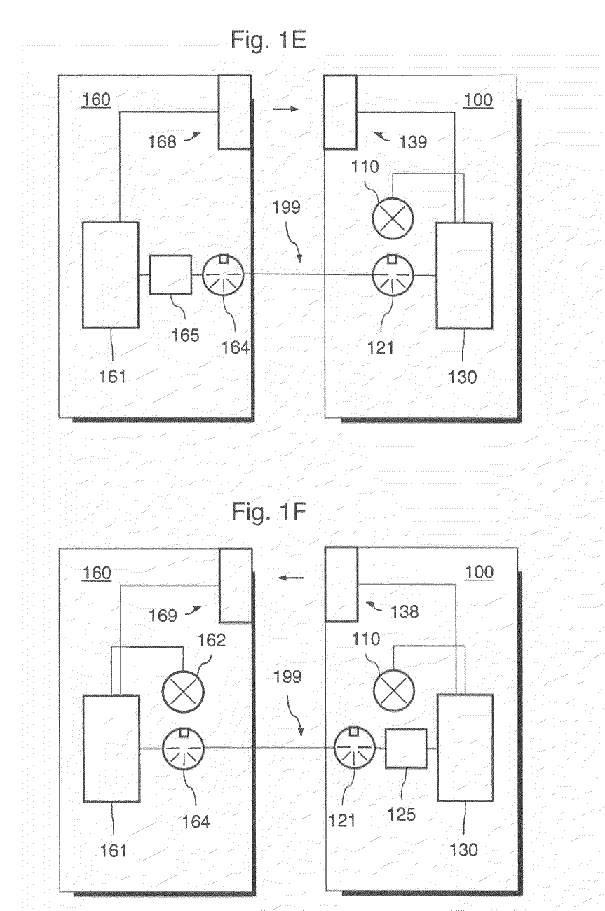

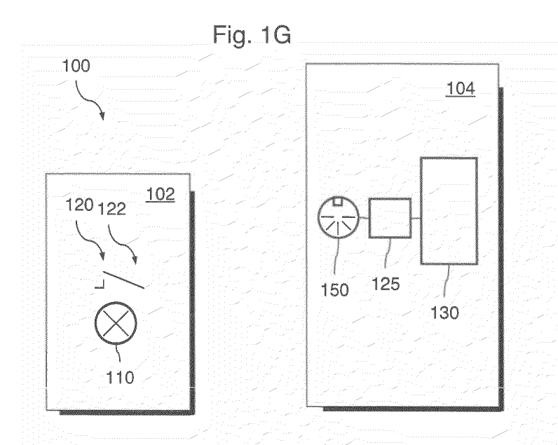

FIG. 1A is a schematic diagram of an electronic device with an illuminating element associated to a connector socket in accordance with embodiments referring to context-sensitively illuminated sockets.

FIG. 1B is a schematic diagram of an electronic device with an illuminating element associated to a control element in accordance with embodiments referring to context-sensitively illuminated control elements.

FIG. 1C is a schematic diagram of an electronic device with an illuminating element associated to a connector socket in accordance with embodiments where socket illumination is controlled in connection with an operable control element.

FIG. 1D is a schematic diagram of an electronic device with a plurality of illuminating elements associated to connector sockets according to another embodiment referring to socket localization.

FIG. 1E is a schematic diagram of an electronic device according to embodiments referring to a connector socket illuminated in response to a received connection request message.

FIG. 1F is a schematic diagram of an electronic device according to embodiments referring to an information output port configured to transmit a connection request message according to another embodiment.

FIG. 1G is a schematic diagram of an electronic device with an illuminating element associated to a control element in accordance with embodiments associating an input port to a context-sensitively illuminated switch.

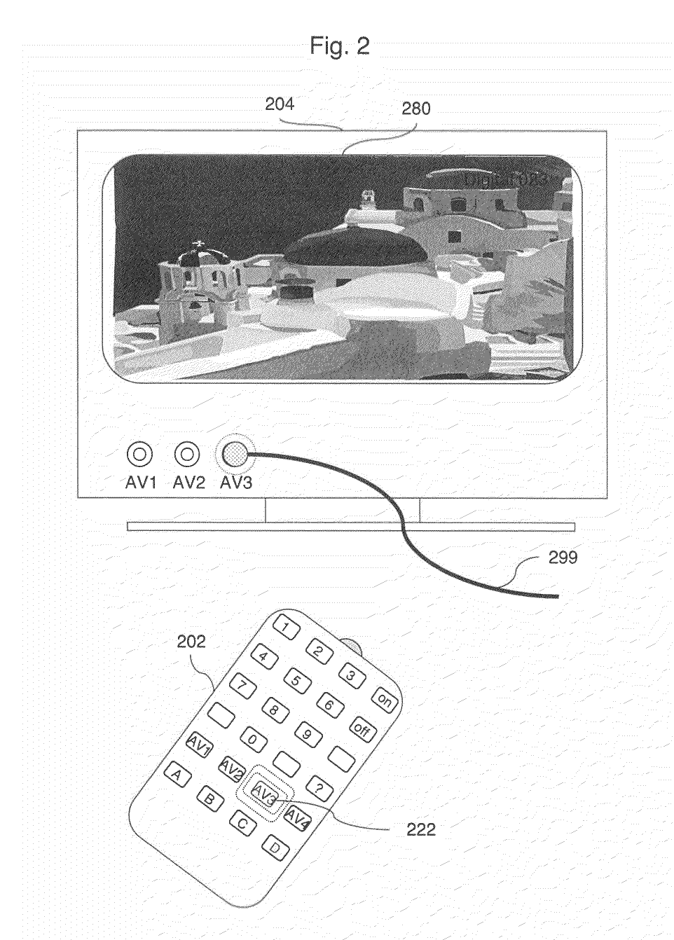

FIG. 2 is a schematic diagram of an electronic device with illuminating elements in accordance with embodiments associating input ports to context-sensitively illuminated control elements.

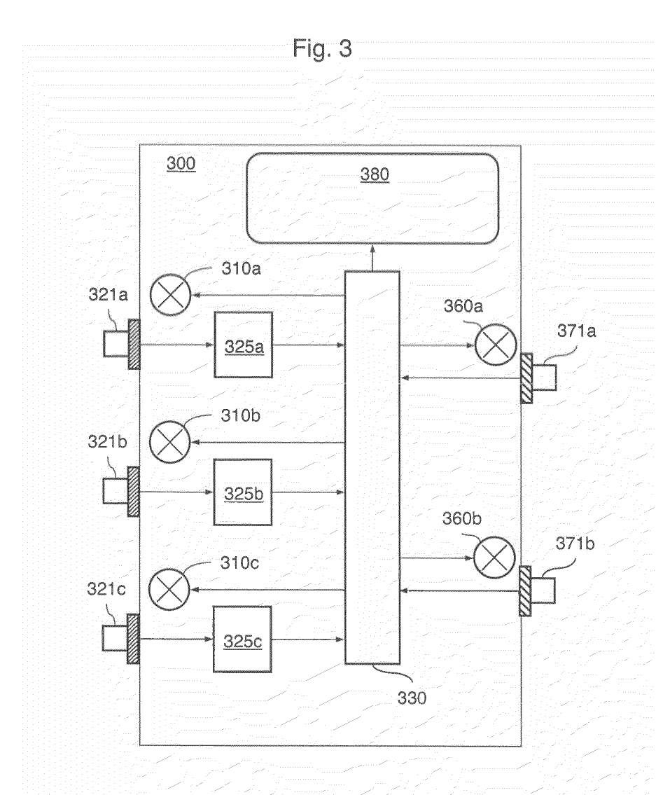

FIG. 3 is a schematic diagram of an electronic device with context-sensitively illuminated operating elements in accordance with further embodiments combining embodiments according to FIGS. 1A to 1F.

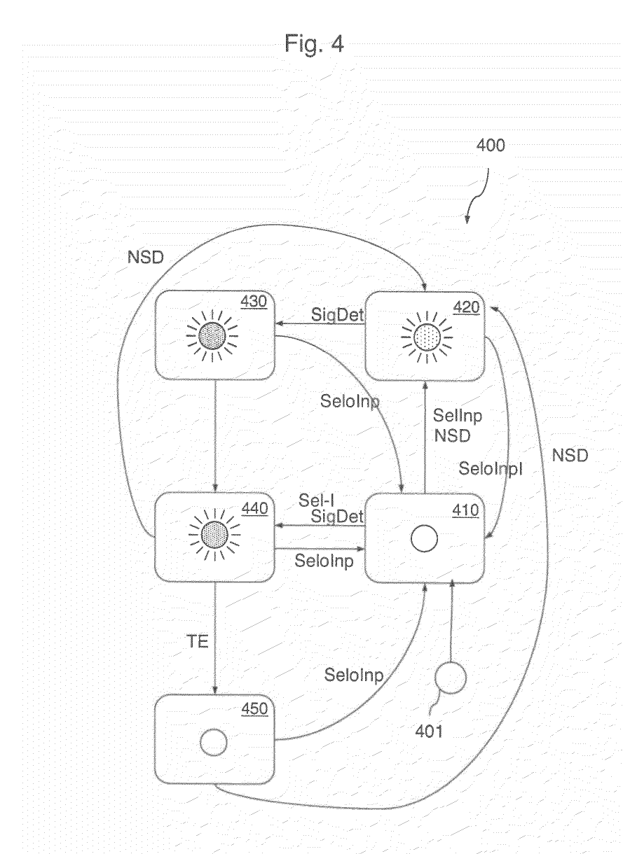

FIG. 4 is a schematic state diagram for illustrating a method of operating an electronic device with illuminating elements in accordance with embodiments associating input ports to context-sensitively illuminated control elements.

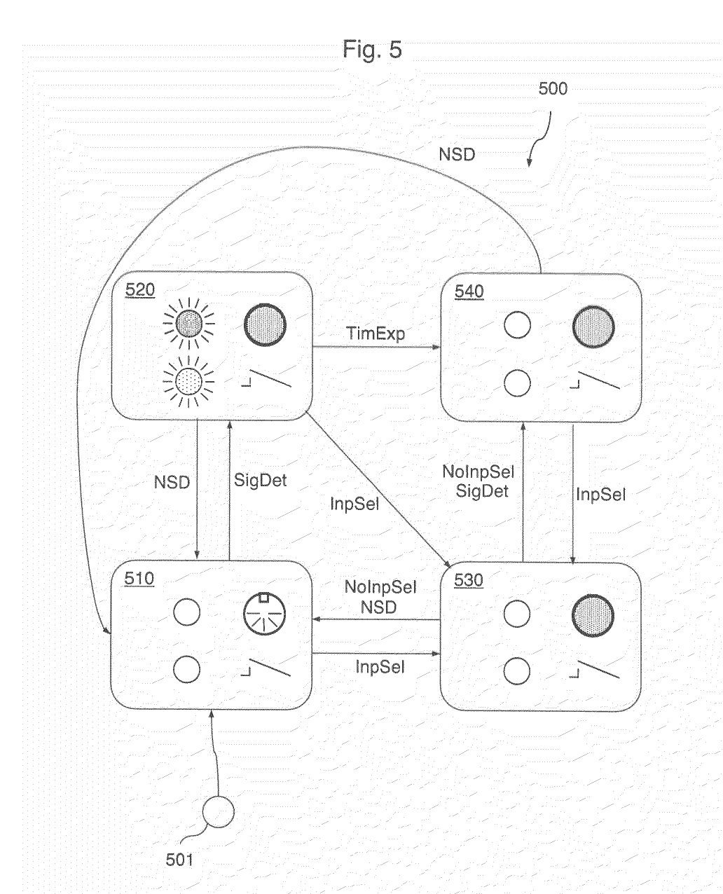

FIG. 5 is a schematic state diagram for illustrating a further method of operating an electronic device with illuminating elements in accordance with embodiments associating input ports to context-sensitively illuminated control elements.

FIG. 1A illustrates an electronic device 100 that may be a consumer electronic device such as a television set, a television set top box, an analogue or digital tuner, a DVD (digital video disk) player, an amplifier apparatus, a compact disc (CD) player, a blu-ray (BD) player, a game console or a video cassette recorder apparatus. The electronic device 100 includes an operating element 120 which performs an electric or optic function and which can take at least two different states by operation of a user.

According to the embodiment illustrated in FIG. 1A, the operating element 120 is a connector socket 121 into/onto which an electrical or optical connection cable can be plugged that may electrically or optically connect the electronic device 100 with a further electronic device, for example a television set-top box, an analogue or digital tuner, a DVD player, a CD player, a BD player, an amplifier apparatus, a game console, a video camcorder or a video cassette recorder. For example, the electronic device 100 is a television set and the further electronic device is a television set top box. The user plugs a connection cable into/onto the connector socket 121 to bring the socket 121 in a plugged state. The user removes the plugged connector from the socket 121 to bring the socket 121 in an unplugged state.

The socket 121 may be a male or female connector socket and can be an audio connector such as a tip-ring-sleeve (TRS) connector, a cinch plug (RCA jack), a TOSLINK connector, a bayonet nut connector (BNC), a diode connector or a video connector such as a mini-DIN connector, cinch plugs, a video-in-video-out (VIVO) connector, a digital visual interface (DVI) connector, a VGA (video graphics array) connector (D-sub 15), or a combined audio and video connector, such as a display port (DisplayPort) connector, a SCART (Syndicat des Constructeurs d'Appareils Radiorécepteurs et Téléviseurs) connector, an IEEE1394 (“Firewire”) connector, another Ethernet connector, for example an RJ45 or an 8P8C modular connector, an XLR connector (“Cannon connector”), a USB (universal serial bus) connector or a HDMI (high-definition multimedia interface) connector.

The electronic device 100 further includes an illuminating element 110 capable of emitting light. The illuminating element 110 may be a light bulb, an LED (light emitting diode), an assembly comprising more than one LED or an element made of or covered with a controllably fluorescent material. The illuminating element 110 is capable of taking at least two different states that are distinguishable by the user. One of the states can be an inactive state in which the illuminating element 110 does not emit light and another state can be an active state in which light is emitted continuously or periodically. According to another embodiment, the illuminating element 110 emits light in both states, wherein the states are characterized by different colors of the emitted light and/or different flashing periodicities.

The illuminating element 110 is arranged in a way such that the user can unambiguously associate the illuminating element 110 with the associated connector socket 121. For example, the illuminating element 110 may be integrated in the socket 121 and emits light through a transparent casing portion of the socket 121. In accordance with another embodiment, the illuminating element 110 is placed on a casing of the electronic device 100 or below a transparent portion thereof in proximity to the socket 121 or surrounding the socket 121. If the electronic device 100 comprises further operating elements, which are not assigned to the illuminating element 110, the illuminating element 110 may be placed closer to the socket 121 to which it is associated than to any of the further operating elements to which it is not associated.

Other embodiments provide a graphical element 115 that associates the illuminating element 110 with the socket 121. The graphical element 115 may be a line, an arrow, or any other suitable sign extending between the illuminating element 110 and the associated socket 121, or a frame embedding both the illuminating element 110 and the associated socket 121, by way of example. The graphical element 115 may be a two-dimensional element, for example a printed adhesive label, or of three-dimensional element, for example a protruding or recessed casing portion.

A controller 130 of the electronic device 100 is capable of performing a user-interactive procedure and to context-sensitively control illuminating element 110. For example, the controller 100 is a processor controlling the illuminating element 110 via a processor output port. In accordance with embodiments referring to electronic devices having a screen, a display or a graphical interface, the user guidance procedure may be an on-screen operating manual display program explaining to the user the function and use of the electronic device 100 by displaying a suitable text on the screen, display or graphical interface. The controller 100 may illuminate the socket 121 when the operating manual display program displays a description passage that refers to the socket 121 or if the user selects a section or a passage of the operating manual referring to the socket 121.

In accordance with another embodiment, the user guidance procedure is a help function accessible via an on-screen display (OSD) menu available on a display, screen or graphical interface of the electronic device 100. For example, the user may activate the help function when the user intends to connect the electronic device 100 with a further electronic device. Then the controller 130 may illuminate the socket 121 when the further electronic device can/shall be connected to the socket 121. The illuminating element notifies 110 the user by changing its state in a way that is perceptible by him. The user can easily associate the description with the relevant operating element and can identify the operating element to which the description refers.

According to other embodiments, the user-interactive procedure is a device selection procedure assisting the user in selecting the appropriate operating element among a plurality of available operating elements in connection with socket identification. In each case the controller 100 context-sensitively controls the illuminating element 110 in dependence on states that the electronic device 100 takes in the course of the respective procedure.

In accordance with an embodiment, the user-interactive procedure is a user guidance procedure for explaining to the user the electric or optic function of the socket 121 or indicating to the user that a text which may be displayed at the screen of a television set refers to a specific socket 121 or that the user has to plug a connection cable into the socket 121, if he intends to add a certain functionality to the electronic device 100. The controller 130 controls the state of the illuminating element 110 such that the illuminating element 110 indicates when the user guidance procedure refers to the socket 121 or when the user guidance procedure indicates that the user has to connect or disconnect a connection cable to/from the socket 121. For example, the illuminating element 110 can be switched from the inactive mode into an active mode if a set-up procedure requires at a certain point in time that a connection cable is to be plugged into the socket 121.

FIG. 1B illustrates an electronic device 100 with a control element 122 operable by the user as illuminated operating element 120. The control element 122 may be a switch, a regulator, a knob or a button, by way of example. According to an embodiment, the control element 122 is a button on a remote controlling device 102 for controlling a remote controllable unit 104 of the electronic device 100. The illuminating element 110 may be arranged closer to the control element 122 than to the other buttons of the remote control 102 such that the user associates the illuminating element 110 with the control element 122.

The controller 130 may perform a user guidance procedure, for example an operating manual display program that explains to the user the function of the control element 122. In accordance with another embodiment, the procedure is a help procedure initiated by a help request activated by the user, wherein the help procedure assists the user in understanding or activating a certain functionality of the electronic device 100. For example, when the operating manual display program or the help procedure refers to a teletext functionality, the controller 130 may highlight a teletext button on the remote controlling device 102. According to another example, volume buttons may be illuminated when the user guidance procedure or the help procedure refers to audio control. In general, the controller changes 130 the state of the illuminating element 110 when the user operating manual display procedure or the help procedure refers to a context in which the function of the control element 122 is relevant.

In accordance to other embodiments, the controller 130 performs an input port selection procedure requiring a predetermined state of the control element 122 at a predetermined point of the procedure and controls the illuminating element 110 in dependence on whether or not the control element 122 is in the predetermined state at the predetermined point in time.

FIGS. 1C to 1G refer to embodiments where a controller 130 of an electronic device 100 performs an input port selection procedure and controls an illuminating element 110 in dependence on whether or not an operating element 120, which may be a connector socket or a control element, is in a predetermined state at a predetermined point in time or procedure. By way of example, in the course of the input selection procedure, the controller 130 may detect an event at the operating element 120 and controls the illuminating element 110 in dependence on an occurrence of the event. For example, the controller 130 changes the state of the illuminating element 110 when the event is detected. Each embodiment of FIGS. 1C to 1G may be combined with each embodiment of FIGS. 1A to 1B.

FIG. 1C refers to an embodiment, where the operating element 120 is a connector socket 121 for connecting an electronic device 100, for example a consumer electronic device such as a television set, with a further electronic device, which may be, for example, a television set top box, an analogue or digital tuner, a DVD player, a CD player, a BD player, an amplifier apparatus, a game console, a video camcorder, a still image camera or a video cassette recorder.

The connector socket 121 may be a male or female connector socket and can be an audio connector such as a TRS connector, a cinch plug, a TOSLINK connector, a BNC, a diode connector, or a video connector such as a mini-DIN connector, cinch plugs, a VIVO connector, a DVI connector, a VGA connector, or a combined audio and video connector, such as a display port connector, a SCART connector, an IEEE1394 connector, another Ethernet connector, for example an RJ45 or an 8P8C modular connector, an XLR connector, a USB connector, a HDMI connector.

The electronic device 100 further includes an illuminating element 110 capable of emitting light. The illuminating element 110 may be a light bulb, an LED (light emitting diode), an assembly comprising more than one LED or an element made of or covered with a controllably fluorescent material. The illuminating element 110 is capable of taking at least two different states that are distinguishable by the user. One of the states can be an inactive state in which the illuminating element 110 does not emit light and another state can be an active state in which light is emitted continuously or periodically. According to another embodiment, the illuminating element 110 emits light in both states, wherein the states are characterized by different colors and/or flashing periodicities.

The illuminating element 110 is arranged in a way such that the user can unambiguously associate the illuminating element 110 with the associated connector socket 121. For example, the illuminating element 110 may be integrated in the socket 121 and emits light through a transparent casing portion of the socket 121. In accordance with another embodiment, the illuminating element 110 is placed on a casing of the electronic device 100 or below a transparent portion thereof in proximity to the socket 121 or surrounding the socket 121. If the electronic device 100 comprises further operating elements, which are not assigned to the illuminating element 110, the illuminating element 110 may be placed closer to the socket 121 to which it is associated than to any of the further operating elements to which it is not associated.

Other embodiments provide a graphical element 115 that associates the illuminating element 110 with the socket 121. The graphical element 115 may consist of or comprise a line, an arrow, or any other suitable sign extending between the illuminating element 110 and the associated socket 121, or a frame embedding both the illuminating element 110 and the associated socket 121, by way of example. The graphical element 115 may be of a two-dimensional type, for example a printed adhesive label, or of three-dimensional type, for example a protruding or recessed casing portion.

A controller 130 controls the state of the illuminating element 110 in dependence on a user selection of an input port associated to the connector socket 121. For example, the electronic device 100 includes a control element 140 with which the user selects the connector socket 121 as input port. The control element 140 may be a switch, a knob, a regulator or a button, for example a button in a control pad of, e.g. a television set, or a button of a remote control unit 102 with which the user controls a remotely controllable unit 104 of the electronic device 100. In accordance with other embodiments the operating element 140 is integrated in the same unit as the socket 121, for example on the surface of the casing of a television set.

The controller 130 performs an input port selection procedure allowing the user to select an input port of the electronic device 100 and changes the state of the illuminating element 110 associated to a connector socket 121 assigned to the selected input port in order to make visible which connector socket 121 is concerned and where this socket can be found at the casing of the electronic device 100. Then the user can easily find and identify that socket, into/onto which he has to plug a connection cable.

In addition, the controller 130 may control the illuminating element 110 in a way that the user can distinguish whether or not a selected and connected socket 121 receives a valid signal. For example, the controller 130 is configured to change the state of the illuminating element 110 in a first active state after the connector socket has been selected and into a second active state after the controller 130 has detected a valid signal at the selected connector socket. In accordance with an embodiment, the color of the emitted light and/or the flushing periodicity depends on whether a valid or invalid connection has been established.

FIG. 1D refers to an electronic device 100 comprising a plurality of illuminating elements 110a-110c each assigned to another operating element 120a-c, wherein the operating elements 120a-c are connector sockets 121a-c. In addition, the electronic device 100 comprises a control element 140, e.g. a switch or a button, operable by the user. A controller 130 is configured to activate all illuminating elements 110a-110c on response to one user action changing a state of the control element 140. In accordance with an embodiment, the electronic device 100 has a remote control 102 and a remote controllable unit 104, wherein the control element 140 is a button 122 on the remote control 102.

For example, by pressing the button 122 on the remote control 102 such connector sockets that are placed at casing portions that are difficult to observe, are made visible and a user may easily find them.

FIG. 1E refers to an electronic device 100 with a connector socket 121 and an illuminating element 110 associated to the socket 121. The electronic device 100 further comprises an information input port 139 configured to receive a connection request message from a further electronic device 160. During an input port selection procedure, the controller 130 changes a state of the illuminating element 110 in response to a received connection request message.

For example, if the further electronic device 160 sends a connection request message via an information output port 168 that is connected with the information input port 139 of the electronic device 100, the controller 130 may illuminate an appropriate socket 121 into which a connection cable from the further electronic device 160 can be plugged.

In accordance with an embodiment, the user indicates to a controller 161 of the further electronic device 160 that the further electronic device 160 is to be connected with the electronic device 100. For this purpose, the user may operate a suitable switch or may select a corresponding menu item at a graphical interface of the further electronic device 160. According to another embodiment, the further electronic device 160 contains a detection element 165 capable of mechanically, optically or electrically sensing a connection cable 199 plugged into or onto a connector socket 164. By plugging the connection cable 199 to the connector socket 164 the user indicates to the controller 161 in the further electronic device 160 that he wishes to connect the further electronic device 160 with the electronic device 100.

The controller 161 in the further electronic device 160 induces the information output port 168 to send the connection request message. The electronic device 100 receives the connection request message and in response to the connection request message the controller 130 in the electronic device 100 may switch on the illuminating element 110. The illuminating element 110 indicates to the user that connector socket 121 to which he has to connect the further electronic device 160.

FIG. 1F refers to a further embodiment which can be combined with the embodiment as illustrated in FIG. 1E. In accordance with this embodiment, the electronic device 100 further includes an information output port 138 that is configured to transmit a connection request message to a further electronic device 160 in response to a selection of a connector socket 121 by the user. The electronic device 160 may contain a detection element 125 capable of mechanically, optically or electrically sensing a connection cable 199 plugged into or onto the connector socket 121.

The user plugs a connection cable 199 into the connector socket 121 for indicating that he intends to connect the electronic device 100 with a further electronic device 160. The controller 130 may sense the presence of the connection cable 199 either by detecting a change in the electric characteristics at the connector socket 121, for example a change in a capacitive coupling between data lines or mechanically, for example, if a prong of the connector cable 199 fits into a recess of the socket 121 and operates a switch, or optically by means of an optical sensor. Via the information output port 138 the controller 130 transmits a connection request message to the further electronic device 160. In response to the connection request message, a controller 161 in the further electronic device 160 may activate an illuminating element 162 illuminating a connector socket 164 to which the user can plug the connector cable 199.

FIG. 1G refers to embodiments where the operating element 120, which is context-sensitively illuminated by an illuminating element 110, is a control element 122. The control element 122 may be placed on a remote control unit 102 for controlling a remotely controllable unit 104 of an electronic device 100 and is illuminated in dependence on a connection status of a connector socket 150. The connector socket 150 may be a male or female connector socket and can be an audio connector such as a TRS connector, a cinch plug, a TOSLINK connector, a BNC, a diode connector, or a video connector such as a mini-DIN connector, cinch plugs, a VIVO connector, a DVI connector, a VGA connector, or a combined audio and video connector, such as a display port connector, a SCART connector, an IEEE1394 connector, another Ethernet connector, for example an RJ45 or an 8P8C modular connector, an XLR connector, a USB connector, a HDMI connector.

The electronic device 100 further includes an illuminating element 110 capable of emitting light. The illuminating element 110 may be an LED (light emitting diode), an assembly comprising more than one LED or an element made of or covered with a controllable fluorescent material. The illuminating element 110 is capable of taking at least two different states that are distinguishable by the user. One of the states can be an inactive state in which the illuminating element 110 does not emit light and another state can be an active state in which light is emitted continuously or periodically. According to another embodiment, the illuminating element 110 emits light in both states, wherein the states are characterized by the color and/or the flashing periodicity.

The illuminating element 110 is placed in a way such that the user can unambiguously associate the illuminating element 110 with the associated control element 122. For example, the illuminating element 110 may be integrated in the control element 122 and emits light through a transparent casing portion of the control element 122. In accordance with another embodiment, the illuminating element 110 is placed on a casing of the electronic device 100 or below a transparent portion thereof in proximity to the control element 122 or surrounding the control element 122. If the electronic device 100 comprises further operating elements that are not assigned to the illuminating element 110, the illuminating element 110 may be placed closer to the control element 122 to which it is associated than to any of the further operating elements to which it is not associated.

Other embodiments provide a graphical element 115 that associates the illuminating element 110 with the control element 122. The graphical element 115 may be a line, an arrow, or any other suitable sign extending between the illuminating element 110 and the associated control element 122, or a frame surrounding in an ambiguous way both the illuminating element 110 and the associated control element 122, by way of example. The graphical element 115 may be of a two-dimensional type, for example a printed adhesive label, or of three-dimensional type, for example a protruding or recessed casing portion.

The electronic device 100 may further comprise a detection element 125 capable of mechanically, optically or electrically sensing a connection cable plugged into or onto the connector socket 121 or a further electronic device connected to the connector socket 121. The detection element 125 may sense the presence of a connection cable either by detecting a change in the electrical characteristics at the connector socket 121, for example a change in the capacitive coupling between data lines, or mechanically, for example by a switch switched by a connector cable end portion prong fitting into a recess of the socket or optically by means of an optical sensor.

A controller 130 performs an input port selection procedure that scans for sockets connected with a connection cable or a further electronic device and changes the state of the illuminating element 110 when it detects a further electronic device at the connector socket 150 or a connection cable plugged into/onto the connector socket 150. The illuminating element 110 can be used to indicate that control element 122 by which the user can select the newly detected further electronic device.

For example, as illustrated in FIG. 2, the user plugs a connection cable 299 to a video camcorder into a connector socket AV3 of a casing of a remotely controllable television apparatus 204. A detection element senses the presence of the plugged connection cable 299 and/or the video camcorder. When the presence of plugged connection cable 299 and/or a further electronic device has been detected, on a remote control 202 for the television apparatus 204 a control button 222 assigned to the connector socket AV3 is illuminated and indicates to the user that he now can press the button 222 in order to select the video camcorder as a media source for rendering media contents contained in the video camcorder on a screen 280.

According to an embodiment, the illuminating element which illuminates the button 222 is deactivated or switched off when the input port selection procedure detects that the further electronic device has been removed from the connector socket AV3 or after the user has selected the connector socket AV3 as active media input port.

According to other embodiments the television apparatus 204 includes further illuminating elements assigned to the connector sockets AV1 to AV3. The further illuminating elements can be controlled in the same or similar manner as those illuminating elements illuminating the buttons in the remote controller device 202. For example, a further illuminating element associated to connector socket AV3 may emit green light while the associated button is illuminated with red flashing light. Both illuminating elements may be switched off at the same time. A method of operating an electronic device having a control element illuminated in dependence on a connection state is described in detail in FIG. 5. Each embodiment of FIGS. 1G and 2 may be combined with each embodiment of FIGS. 1C to 1F.

FIG. 3 refers to an embodiment combining some of the embodiments described above. An electronic device 300 having a screen 380, for example a television set, comprises a plurality of connector sockets 321a to 321c configured to receive audio and/or video signals for being displayed on the screen 380. Each connector socket 321a to 321c may be associated to a first illuminating element 310a to 310c and to a detection element 325a to 325c. The detection elements electrically, mechanically or optically sense the presence of connection cables plugged into/onto the respective connector socket 321a to 321c or the presence of further electronic devices connected to the connector sockets 321a to 321c. The electronic device 300 further includes a plurality of user operable control elements, for example buttons 371a to 371b, wherein at least some of them may be associated with second illuminating elements 360a to 360c respectively. A controller 330, for example a processor, controls the first and second illuminating elements 310a to 310c, 360a to 360b in response to signals received from the detection elements 325a to 325c and the buttons 371a to 371b.

For example, by pushing one of the buttons 371a to 371b or both of them at the same time, all illuminating elements 310a to 310c associated to the connection sockets 321a to 321c are activated such that a user can easily localize them at the casing of the electronic device 300.

According to another example, one of the illuminating elements 310a to 310c, 360a to 360b is activated, when an on-screen operational menu program or an on-screen help menu refers to the function of the associated connector socket 321a to 321c or button 371a to 371b.

In accordance with another example, a first button 371a is associated to a first connector socket 321a and the illuminating element 310a associated to the first connector socket 321a is activated when the user selects the first connector socket 321a as an active input port by pushing the first button 371a. The first illuminating element 310a may then change its state a second time, when the controller 330 detects a valid signal on the first connector socket 321a.

According to another example, one of the detection elements 325a to 325c may detect the presence of a connector cable plugged into one of the connector sockets 321a to 321c and the controller 330 may control one of the second illuminating elements 360a to 360b associated to a button 371a to 371b for assisting the user to push the correct button for selecting the respective connector socket 321a to 321c, or the first illuminating element 310a to 310c associated to the respective connector socket 321a to 321c, or both.

In each case, the controller 330 may control the illuminating elements 310a to 310c and 360a to 360b such that they are deactivated, or switched off after expiry of a surveillance period.

The state diagram 400 of FIG. 4 refers to a method of operating an electronic device with an illuminating element associated to a connector socket of an input port. The method is an input port selection procedure for selecting an input port for receiving media data like audio, video or still-image data to be rendered or recorded at the electronic device.

An entrance 401 of the procedure may be called by an embedding routine executed by the controller of the electronic device. After the entrance, the procedure is in a not-selected-state 410 in which the illuminating elements and the surveillance timer are inactive. According to an embodiment referring to an electronic device having a screen, a display or a graphical interface, a reserved display area displays no service information.

When a user selects an input, either by pressing a button in a control pad or on a remote control device and if the controller does not detect a valid signal on the selected input, the procedure switches to a no-input-signal-state 420 in which the controller has activated the illuminating element. For example, the illuminating element may flash and the color of the emitted light is red. In the reserved display area a text informing the user to plug a connection cable into/onto a specific connector socket may appear.

When a user connects a suitable electronic device to the illuminated connector socket, the electronic device may receive a valid signal. When the controller detects a valid signal at the illuminated connector socket, the procedure switches into a signal-detected-state 430. The illuminating element may be switched into another state in which it, for example, continuously emits green light.

The text displayed in the reserved display region may be deleted and the surveillance timer may be started, wherein the procedure switches to a wait-timer-state 440 in which the illuminating element still indicates a valid signal on a selected connector socket. The procedure directly switches from the non-selected-state 410 to the wait-timer-state 440 if the controller immediately detects a signal at the time the user selects the input-port.

When the surveillance period expires, the procedure changes to a signal-playback-state 450 in which the surveillance timer and the illuminating elements are switched off and no text appears in the reserved display region. The procedure generally switches to the no-input-signal-state 420 when no signal is detected at the selected input and to the non-selected-state 410 when the user selects another input port.

The state diagram 500 of FIG. 5 refers to a method of operating an electronic device with a first illuminating element at a connector socket of an input port and a second illuminating element at a button with which the user can select the input port. The method is an input port selection procedure for selecting an input port for receiving data, for example media data like audio, video or still-image data to be rendered or recorded at the electronic device.

An entrance 501 of the procedure may be called by an embedding routine executed by the controller of the electronic device. After the entrance, the procedure is an input-unused state 510 in which the input port is not used. No connection cable is connected to the connector socket assigned to the input port and no signal can be detected at the input port. The first illuminating element assigned to the connector socket and the second illuminating element assigned to a button for selecting the connector socket and a surveillance timer are inactive.

When the controller detects a signal a any of the connector sockets, for example because someone has plugged a connection cable into it, the procedure switches to a signal-detected-state 520 in which both illumination elements are activated and the surveillance timer is started. For example, the illumination element assigned to the connector socket may flash green for indicating a valid signal at the respective input and the illumination element associated to the button assigned to the same connector socket may flash red for indicating that the user has to push the button if he actually wants to select the newly plugged further electronic device as a media source.

From the signal-detected-state 520 the procedure switches to an input-selected-state 530 when the user pushes the illuminated button. In the input-selected-state 530, both the illuminating elements and the surveillance timer are switched off.

If, however, the surveillance timer expires before the user activates the illuminated button, it is assumed that the user does not actually want to use the newly plugged connection as media source at this point in time. The procedure switches from the signal-detected-state 520 to an input-selectable-state 540 in which both illuminating elements and the surveillance timer are switched off.

The procedure directly switches into the input-selected-state 530 each time the user selects an input and switches to the input-unused-state 510 when no signal is detected.

1. An electronic device comprising
an operating element (120) configured to perform an electric or optic function and being operable;
an illuminating element (110) arranged in a way that it can be associated with the operating element (120) and configured to take at least two different states that distinguish from each other in a way of notification; and
a controller (130) configured to perform a user guidance procedure for explaining the function of the operating element (120) and/or an input port selection procedure for selecting an input port and to control the illuminating element (110) in dependence on a progress of the respective procedure.

2. The electronic device of claim 1, wherein
the controller (130) is configured to perform the user guidance procedure and to change the state of the illuminating element (110) when the user guidance procedure refers to a context in which the function of the operating element (120) is relevant.

3. The electronic device of claim 2, wherein
the operating element (120) is a connector socket (121) via which the electronic device (100) is connectable with a further electronic device.

4. The electronic device of claim 2, wherein
the operating element (120) is a control element (122).

5. The electronic device of claim 2, further comprising
a remote controlling device (102) including buttons, wherein
the operating element (120) is one of the buttons.

6. The electronic device of claim 1, wherein the
controller (130) is configured to perform the input port selection procedure and to control the illuminating element (110) in dependence on whether or not the operating element (120) is in the predetermined state at the predetermined point in the procedure.

7. The electronic device of claim 1, wherein the
controller (130) is configured to perform the input port selection procedure, to detect an event in the course of the input port selection procedure and to control the illuminating element (110) in dependence on an occurrence of the event.

8. The electronic device of claim 6, wherein
the operating element (120) is a connector socket (121) via which the electronic device (100) is connectable with a further electronic device.

9. The electronic device of claim 8, wherein
the controller (130) is configured to change the state of the illuminating element (110) after that input port which is associated to the connector socket (121) has been selected.

10. The electronic device of claim 9, further comprising
an operable control element (140), wherein the controller (130) is further configured to change the state of the illuminating element (110) when the control element (140) has been operated.

11. The electronic device of claim 9, wherein
the controller (130) is further configured to change the state of the illuminating element (110) when the controller (130) detects no valid signals at the selected connector socket (121).

12. The electronic device of claim 8, further comprising
an information input port (139) configured to receive a connection request message from a further electronic device (160), and wherein the controller (130) is configured to change the state of the illuminating element (110) in response to a connection request message received via the information input port (139).

13. The electronic device of claim 12, further comprising
an information output port (138) configured to transmit a connection request message to a further electronic device (160), and wherein the controller (130) is configured to generate a connection request message in response to a selection of the connector socket (121).

14. The electronic device of claim 6, wherein
the operating element (120) is a control element (122).

15. A method of operating an electronic device, the method comprising
performing a user guidance procedure for explaining the function of an operating element (120) or an input port selection procedure for selecting an input port;
illuminating an operating element (120) operable in dependence on a progress of the respective procedure.
